(19) United States
(12) Patent Application Publication
(10) Pub. No.: US 2025/0229749 A1
(43) Pub. Date: Jul. 17, 2025

(54) KINETIC ENERGY RECAPTURE APPARATUS AND SYSTEM

(71) Applicant: Angela Courtney, Inglewood, CA (US)

(72) Inventor: Angela Courtney, Inglewood, CA (US)

(21) Appl. No.: 18/698,221

(22) PCT Filed: Nov. 8, 2022
(86) PCT No.: PCT/US2022/079456

§ 371 Date: Apr. 3, 2024

Related U.S. Application Data
(60) Provisional application No. 63/264,678, filed on Nov. 30, 2021.

(51) Int. Cl. B60T 1/10; F16D 61/00; F16H 55/46

(52) U.S. Cl. CPC B60T 1/10; F16D 61/00; F16H 55/46

(57) ABSTRACT

A kinetic energy recovery apparatus for use in powered vehicles can connect to the axle of the car or similar vehicle. As the vehicle moves forward, the kinetic energy from the forward spin of the axle is transformed into electricity by the apparatus. A belt connected to the device transfers the energy from the spinning axle to a generator, which generates electricity which is then stored in a battery.

### CROSS-REFERENCE TO RELATED APPLICATIONS

This application claims the benefit of priority of U.S. provisional patent application No. 63/264,678, filed Nov. 30, 2021, the contents of which are herein incorporated by reference.

### BACKGROUND OF THE INVENTION

### 1. Field of the Invention

Embodiments of the invention relate generally to kinetic energy recapture devices, and more specifically, to kinetic energy recapture methods and devices for powered vehicles that combines a belt-wheel device attached around a car axle with a generator and battery.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Rising fuel costs and environmental concerns have increased demand for electric, hybrid and generally fuel-efficient vehicles. The energy-efficiency of electric, hybrid and other fuel-efficient vehicles could be improved if the kinetic energy generated by such vehicles was properly recaptured and stored.

In view of the foregoing, there is a need for solutions for improving the energy efficiency of vehicles.

### SUMMARY OF THE INVENTION

In some embodiments, set forth herein is a belt-wheel made from two halves that are fastened together around an axle.

In other embodiments, set forth herein is a system which includes a generator, a battery, a belt-wheel, and an axle. The belt-wheel, in some embodiments, is comprised of two belt-wheel halves that are fastened together around the axle. A serpentine belt can be connected to the belt-wheel and the generator, and batteries can be connected to the generator, in certain examples set forth herein.

Embodiments of the present invention provide a device comprising a belt-wheel; and an axle, wherein the belt-wheel comprises a first belt-wheel half and a second belt-wheel half fastened together and around the axle.

Embodiments of the present invention further provide a system comprising a generator; a belt-wheel; and an axle having the belt wheel attached thereto; a drive mechanism mechanically coupling the belt-wheel with the generator; and an auxiliary battery electrically coupled to the generator, wherein the belt-wheel comprises two belt-wheel halves fastened together and around the axle.

Embodiments of the present invention also provide a vehicle comprising the system described herein.

Embodiments of the present invention also provide a method of using a vehicle having the system as described herein, the method comprising moving the vehicle forward; turning the belt-wheel attached to the axle; and operating the generator via the driving mechanism.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of two belt-wheel halves connected together to form a single device, according to an exemplary embodiment of the present invention;

FIG. 2 illustrates a perspective view of the assembled belt-wheel of FIG. 1 attached around an axle, according to an exemplary embodiment of the present invention;

FIG. 3 illustrates an interior perspective view of the two belt-wheel halves of FIG. 1 shown alongside a tape measure to give a size perspective of the diameter of the belt-wheel halves, according to an exemplary embodiment of the present invention;

FIG. 4 illustrates an interior perspective 3 view of the two belt-wheel halves of FIG. 1 shown alongside a tape measure to give a size perspective of the thickness of the belt-wheel halves, according to an exemplary embodiment of the present invention;

FIG. 5 illustrates a perspective view of an assembled belt-wheel, attached around an axle, where its motion, as transferred by the serpentine belt or similar pulley, is shown, according to an exemplary embodiment of the present invention;

FIG. 6 illustrates a cut-away perspective view of a vehicle chassis showing the belt-wheel and axle of FIG. 5, as located relative to other elements of the vehicle chassis, including a turbine, a battery management system and a rechargeable battery, according to an exemplary embodiment of the present invention; and

FIG. 7 illustrates another cut-away perspective view of a vehicle chassis showing the belt-wheel and axle of FIG. 5 as located relative to other elements in the vehicle, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a kinetic energy recovery apparatus for use in powered vehicles. The apparatus contains a device which connects to the axle of the car or similar vehicle. As the vehicle moves forward, the kinetic energy from the forward spin of the axle is transformed into electricity by the apparatus. A belt connected to the device transfers the energy from the spinning axle to a generator, which generates electricity which is then stored in a battery.

As provided herein, a “belt-wheel” is a wheel with a grooved perimeter surface, unless specified otherwise, that can be connected to a belt or other similar pulley that interfaces with the grooves of the outer barrel surface of the belt-wheel.

The “outer barrel surface” of the belt-wheel is that outer perimeter surface which can interface with the serpentine belt or other pulley.

A “serpentine belt” is a flexible belt that can transfer the rotational energy from the belt-wheel, on the axle, to the generator. Unless specified otherwise, the serpentine belt contains grooves on one side of the belt that interact with the grooves on the belt-wheel outer barrel surface such that the grooves of the serpentine belt align with the grooves of the belt-wheel. A serpentine belt may also include any equivalent connection mechanism such as a rope or chain, a flat belt, a v-belt, or the like.

A “belt-wheel half” is a belt-wheel as described above cut in half along a diameter of the belt-wheel.

“Eyelets” or “securing eyelets” are washer-shaped areas of the belt-wheel used to connect the two halves together via traditional mechanical fasteners such as bolts, screws, welding or a combination thereof.

Certain embodiments disclosed herein are capable for use as energy regeneration and reuse systems within powered vehicles. These embodiments can be built into new vehicles as well as retrofitted to existing vehicles. These embodiments are suitable for attachment to a car axle and rely on the forward spin of the axle while the vehicle is moving forward, using the kinetic energy of the spinning axle to ultimately generate electricity.

The kinetic energy recapture apparatus described herein can include a device that attaches to an axle. The device includes two halves of a belt-wheel that attach together around the axle. This two-piece design allows the device to be retrofitted to a vehicle that has already been produced. The belt-wheel halves can be made from metal, plastic or other polymers, ceramic or a combination of materials. Each belt-wheel half may contain eyelets attached to the device near the face of the belt-wheel half that connects to the second belt-wheel half, such that the eyelets of the first half may be aligned with the eyelets of the second half. Traditional mechanical securing mechanisms such as a bolt and nut may be used to secure the two belt-wheel halves together through the aligned eyelets. Screws, nails and other traditional fasteners may also alternatively be used to secure the two belt-wheel halves together through the eyelets. Alternatively, the two halves may be welded together, glued together, or similarly fastened together.

In an alternative embodiment, the kinetic energy recapture apparatus described herein includes a device that attaches to an axle, where the device includes a single-piece belt-wheel that is attached around the axle such as during the production of the vehicle. The belt-wheel can be made from metal, plastic or other polymers, ceramic or a combination of materials.

The inner-diameter of the belt-wheel is such that it will fit around the diameter of the axle to which it is ultimately attached. The belt-wheel may connect to the axle in a stationary manner, such that the device will rotate with the axle rotation without slip, by a snug fit between the device and the axle. The device will complete one rotation for each rotation completed by the axle when in use. Alternatively, in some other examples, the belt-wheel device may be welded, glued, or otherwise affixed to the axle. In certain examples, the outer diameter of the belt-wheel device is sized such that the outer edges of the belt-wheel device will not touch other nearby elements of the car chassis or the ground.

Embodiments of the belt-wheel device can include grooves in the outer-barrel surface of the belt-wheel. The grooves in this outer surface can interact with similar grooves in a serpentine belt, creating an interface between the belt-wheel and a serpentine belt. In other embodiments, the belt-wheel outer-barrel surface may contain raised notches or pegs or other means to interface with the serpentine belt or may be smooth. A serpentine belt can be used to connect the belt-wheel device to a generator. As the vehicle is driven forward, such as when powering or coasting forward, the belt-wheel device can rotate forward as the axle of the vehicle rotates forward. The serpentine belt will transfer this rotational kinetic energy to the generator, which will generate electricity via a flywheel or other rotational energy-generation means. In alternative embodiments of the invention, other similar connecting elements, such as ropes, bands, and other pulleys, may be used to connect the belt-wheel and the generator in place of or in addition to the serpentine belt.

The energy generated in the generator may be transferred to and stored in an energy storage device, such as a battery. In some embodiments, the battery is an auxiliary battery to the vehicle's main battery. This auxiliary battery can be used to charge the car's main battery.

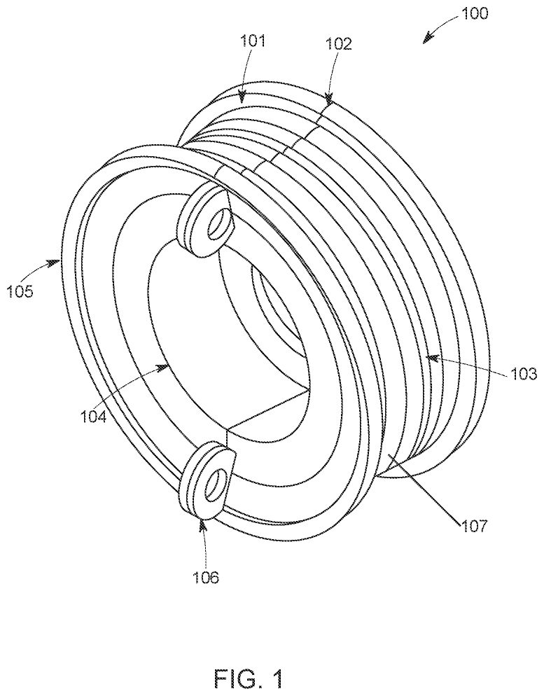

FIG. 1 illustrates an exemplary embodiment of a belt-wheel device 100 (also simply referred to as device 100) with two belt-wheel halves 101 connected together. Typically, the two belt-wheel halves 101 will be formed from equally dividing the belt-wheel device 100 along a central radial axis, as shown in FIG. 1. In other words, each of the first and second belt-wheel halves 101 can have an equal mass.

The device 100, as connected, shows a seam 102 or interface between the two halves. The seam 102 of a first one of the belt-wheel halves 101 can mate with a second one of the belt-wheel halves 101 to form a continuous outer surface when mated together.

The outer barrel surface 107 of the belt-wheel device 100 can include grooves 103 for interfacing with a serpentine belt (not shown). The grooves 103 may include a plurality of uniform rises and falls along an axial axis of the outer barrel surface 107. The grooves 103 may be continuous about each of the belt-wheel halves 101. Each of the grooves 103 may span the outer barrel surface 107 at a given, unchanging axial spacing. A shoulder may be defined by peripheral edges 105, disposed on each side of the outer barrel surface 107 to prevent a belt from slipping of the belt-wheel device 100.

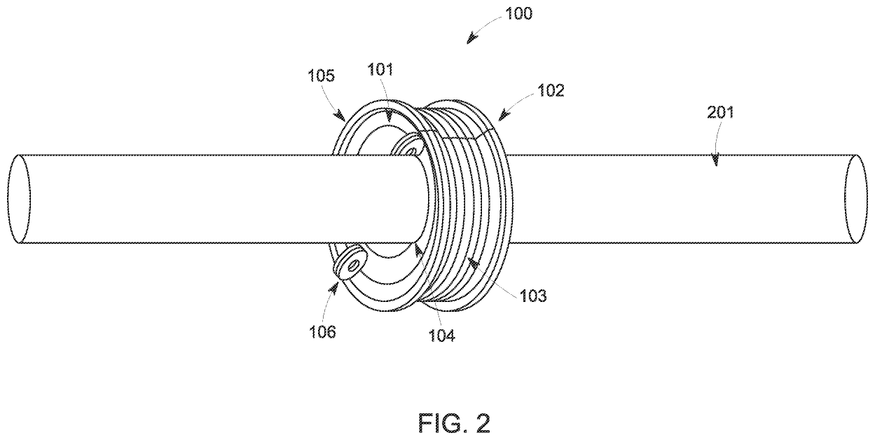

An inner diameter 104 of the device 100 can match, or, in some embodiments, be slightly less than, that of the axle (not shown, see FIG. 2) upon which the device 100 is ultimately connected. An outer diameter of the device 100 is defined by the size of the peripheral edges 105 of the outer barrel surface 107 of the device 100.

As shown, eyelets 106 of the two halves 101 of the device 100 have been aligned. The eyelets 106 of each of the two halves 101 may form a plane that intersects through a central region of the axle 201 (see FIG. 2) upon which the device 100 is installed. The eyelets 106 of one of the halves 101 may have an outward facing surface that rests against an outward facing surface of the other one of the eyelets 106, as shown in FIG. 1. Typically, four eyelets 106 are disposed on each of the two halves 101, where two eyelets 106 can be positioned on opposite sides of the outer barrel surface 107, adjacent the seam 102. Typically, the outward facing surface of the eyelets 106 can align with a plane defined by the seam 102.

FIG. 2 shows the belt-wheel device 100 of FIG. 1 attached around an axle 201. In some embodiments, the seam 102 can bisect the axle 201 through a central axial plane thereof. The device 100 may be attached to the axle 201 by a friction fit when disposing the halves 101 on each side of the axle 201 and connecting the mating eyelets 106 together with fasteners, as discussed above. In some embodiments, a friction reducing coating or material may be added between the axle 201 and the device 100 to prevent slippage therebetween. In some embodiments, a weld may be used to further secure the device 100 to the axle 201.

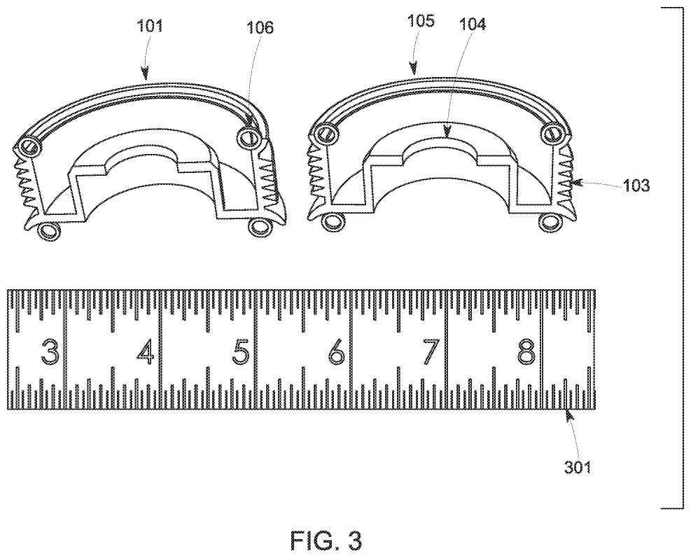

FIG. 3 additionally shows the device 100 of FIG. 1 with the two belt-wheel halves 101 separate rather than attached. A standard inch tape measure 301 shows the size perspective of the device. Of course, it should be understood that the size illustrated is an exemplary size for the device 100, and the device 100 may be sized smaller or larger, depending on the specific application.

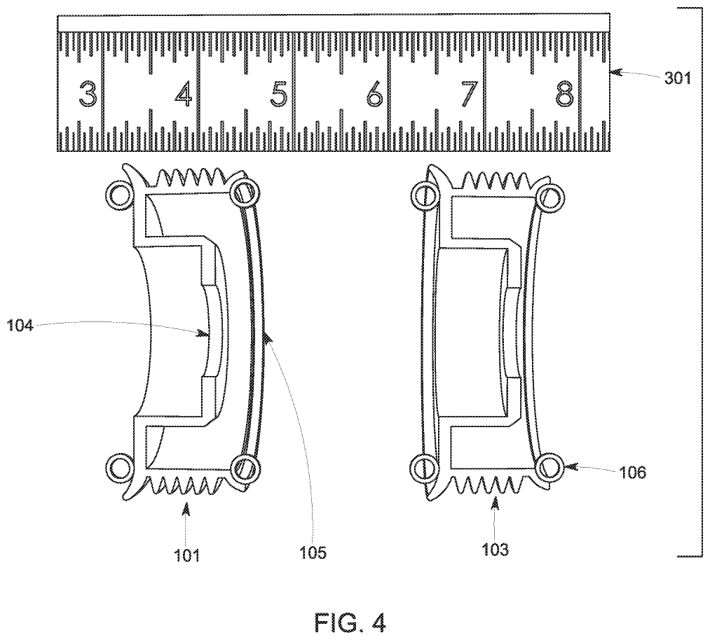

FIG. 4 also shows the two belt-wheel halves 101 separately rather than attached together. A standard inch tape measure 301 again shows the size perspective of the device 100. Of course, it should be understood that the size illustrated is an exemplary size for the device 100, and the device 100 may be sized smaller or larger, depending on the specific application.

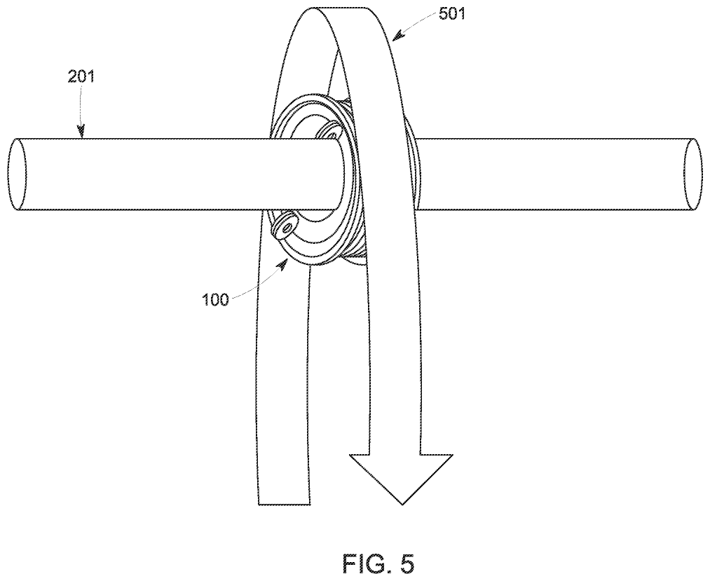

FIG. 5 again shows the device 100 connected about an axle 201 and illustrates the rotational motion 501 of the device 100 about the axle 201 as would be transferred by a serpentine belt.

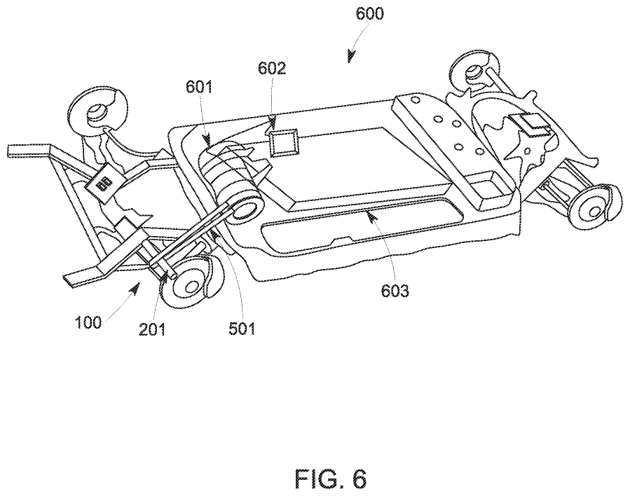

FIG. 6 depicts the device 100 as located on an axle 201 with the rotational motion 501 shown as connected within one embodiment of a vehicle chassis 600 using the device 100. The device 100, as installed within this vehicle system, is further connected to a turbine 601, a battery management system 602, and an auxiliary battery 603.

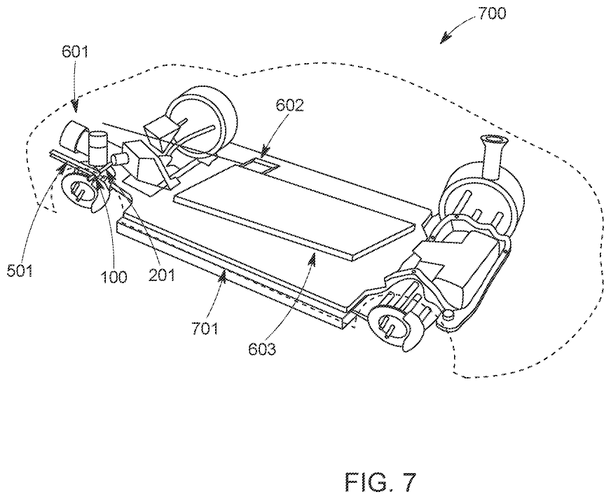

FIG. 7 alternatively depicts the device 100 used in a system as shown in FIG. 6 in a different, electric car body 700. As depicted in FIG. 6 and FIG. 7, the device 100 can be located on either the front or back axle 201 of the car. The rotational motion 501 can be transferred by the serpentine belt to the turbine 601. The energy generated can be transmitted to the auxiliary battery 603 and to the car's main battery 701, as managed by the battery management system 602.

In some embodiments, the battery management system 602 can selectively charge the auxiliary battery, a second auxiliary battery, or the main battery, for example. In some embodiments, the auxiliary battery, for example, may be used to charge a portion of the vehicles on-board battery system (such as those used to drive an electric vehicle), while the battery management system 602 can charge a second auxiliary battery. Thus, one auxiliary battery may be charged via the system, according to embodiments of the present invention, while the other auxiliary battery is used to charge the on-board electric vehicle battery system.

In some embodiments, one or more auxiliary batteries may be charged by movement of the vehicle and then discharged by a drain outside the vehicle. For example, the auxiliary batteries may be charged during a driver's use of the vehicle during the day, and connected to the driver's home when parked to be used to supply power to the home, to another electric vehicle, or to the on-board electric vehicle batteries. In this embodiment, a second auxiliary battery may not be needed, as the single auxiliary battery, when the vehicle is parked and the generator is no longer charging the single auxiliary battery, can then be used to directly charge the on-board electric vehicle battery.

An embodiment of the invention herein described is a device that includes a belt-wheel and an axle, such that the belt wheel is composed of two halves fastened together around the axle. The device has an outer surface along the perimeter of the wheel that has grooves configured to attach to a serpentine belt. The device further includes a serpentine belt coupled to the belt-wheel that interacts with the belt-wheel via the grooves. The two halves of the belt-wheel may contain eyelets. The eyelets of one half can be aligned with the eyelets of the other half, and standard connectors such as bolts or screws can be used to connect the two halves via the eyelets. Alternatively, the two halves can be welded together. The device may also be welded to the axle. The belt-wheel device can be made from metal or plastic or a combination of materials. The axle will be a standard car axle.

A system containing an embodiment of the present invention can include a generator, the belt-wheel device made from two halves of a belt-wheel connected around an axle, a serpentine belt that is coupled to the belt-wheel and the generator, and an auxiliary battery connected to the generator so that energy can be transferred from the generator to the battery. A second battery can also be coupled to the auxiliary battery. The system can also include a battery management system. The belt-wheel device can again be made from metal or plastic or a combination of materials. The system can be implemented in a car, for example. To use this system in a car, the car can be driven forward while operating the generator. The system can be used any time the car is moving forward, including during acceleration, braking or coasting. While in use, the system can directly charge the auxiliary battery or the second battery or charge the second battery from the auxiliary battery.

In some embodiments, the system can include a method for engaging or disengaging the belt from driving the generator. For example, the device 100, or a pulley where the belt interacts with the generator, may include a clutch that may permit free rotation thereof. For example, if the pulley on the generator includes a clutch (for example, similar to that used for driving a vehicles air conditioning compressor), the clutch can disengage, where turning of the pulley by the belt (driven by the device 100 on the axle 201) would not turn the generator. Of course, other mechanisms may be provided to disengage the mechanical connection between the device 100 and the generator.

### EXAMPLES

### Example 1

According to a prophetic method of making one embodiment of the present invention, a wheel from a conventional belt-pully can be purchased from an online retailer such as Amazon or McMaster-Carr (see, e.g., https://www.mcmaster.com/timing-belt-pulleys/). This wheel can then be cut in half along a diameter of the wheel to create two wheel halves. Metal washers can be welded to the wheel to form securing eyelets. The two wheel halves can then be placed around an axle of the size of the original inner diameter of the wheel. Bolts, screws or other fasteners can be used to secure the two halves together around the axle of a car via the eyelets. The two wheel halves can alternatively be welded together, and the connected halves can also be welded to or otherwise connected directly to the axle if desired. A serpentine belt or similar drive member can then be connected to the device so as to interact with the grooves in the exterior of the device. The device can then be connected to a generator via the pulley, and the generator can be connected to a battery.

### Example 2

According to a prophetic means of using one embodiment of the present invention, a car, fitted with the device as described in Example 1, can be driven forward. Any time the car is moving forward, such as when the car is accelerating forward or coasting forward, the axle to which the device is connected to will spin forward. The forward spin of the device on the axle will pull the serpentine belt, which will rotate the flywheel in the generator to generate electricity, which can be used to charge the battery.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A device comprising:
an axle;
a belt-wheel comprising a first belt-wheel half and a second belt-wheel half fastened together and around the axle, wherein:
the first belt-wheel half includes a first inner surface;
the second belt-wheel half includes a second inner surface;
the first inner surface aligning with the second inner surface to form the belt-wheel with a seam defined between the first belt-wheel half and the second belt-wheel half; and
the belt-wheel has an outer barrel surface configured to accept a serpentine belt;
a first set of two upper eyelets disposed on a top end, on opposite sides of the outer barrel surface, adjacent the seam, of the first belt-wheel half;
a second set of two upper eyelets disposed on a top end, on opposite sides of the outer barrel surface, adjacent the seam, of the second belt-wheel half;
a first set of two lower eyelets disposed on a bottom end, on opposite sides of the outer barrel surface, adjacent the seam, of the first belt-wheel half; and
a second set of two lower eyelets disposed on a bottom end, on opposite sides of the outer barrel surface, adjacent the seam, of the second belt-wheel half, wherein
the first set of two upper eyelets align with the second set of two upper eyelets, and the first set of two lower eyelets align with the second set of two lower eyelets, when the first inner surface is aligned with the second inner surface; and
the first and second sets of two upper eyelets and the first and second sets of two lower eyelets each extend axially beyond peripheral edges of the outer barrel surface.

2. (canceled)

3. The device of claim 1, further comprising a serpentine belt mechanically coupled to the belt-wheel.

4. (canceled)

5. (canceled)

6. The device of claim 1, wherein the eyelets of the first belt-wheel half are fastened to the eyelets of the second belt-wheel half to secure the belt-wheel on the axle.

7. The device of claim 1, wherein the first and second belt-wheel halves are fastened together by at least one fastener selected from the group consisting of bolts, screws, nails and a weld.

8. The device of claim 1, wherein more than 50% by weight of the belt-wheel is metallic.

9. The device of claim 1, wherein more than 50% by weight of the belt-wheel is plastic.

10. The device of claim 1, wherein the belt-wheel is welded to the axle.

11. A system comprising:
a generator;
a belt-wheel;
an axle having the belt wheel attached thereto, wherein the belt-wheel comprises two belt-wheel halves fastened together and around the axle, wherein:
the first belt-wheel half includes a first inner surface;
the second belt-wheel half includes a second inner surface;
the first inner surface aligning with the second inner surface to form the belt-wheel with a seam defined between the first belt-wheel half and the second belt-wheel half; and
the belt-wheel has an outer barrel surface configured to accept a serpentine belt;
a drive mechanism mechanically coupling the belt-wheel with the generator;
an auxiliary battery electrically coupled to the generator;
a first set of two upper eyelets disposed on a top end, on opposite sides of the outer barrel surface, adjacent the seam, of the first belt-wheel half;
a second set of two upper eyelets disposed on a top end, on opposite sides of the outer barrel surface, adjacent the seam, of the second belt-wheel half;
a first set of two lower eyelets disposed on a bottom end, on opposite sides of the outer barrel surface, adjacent the seam, of the first belt-wheel half; and
a second set of two lower eyelets disposed on a bottom end, on opposite sides of the outer barrel surface, adjacent the seam, of the second belt-wheel half, wherein
the first set of two upper eyelets align with the second set of two upper eyelets, and the first set of two lower eyelets align with the second set of two lower eyelets, when the first inner surface is aligned with the second inner surface; and
the first and second sets of two upper eyelets and the first and second sets of two lower eyelets each extend axially beyond peripheral edges of the outer barrel surface.

12. The system of claim 11, further comprising a second battery electrically coupled to the auxiliary battery.

13. The system of claim 11, wherein the drive mechanism is a belt.

14. The system of claim 11, further comprising an auxiliary battery management system.

15. The system of claim 11, wherein more than 50% by weight of the belt-wheel is metallic.

16. The system of claim 11, wherein more than 50% by weight of the belt-wheel is plastic.

17. A vehicle comprising the system of claim 11.

18. A method of using the vehicle of claim 17, comprising:
moving the vehicle forward;
turning the belt-wheel attached to the axle; and
operating the generator via the driving mechanism.

19. The method of claim 18, further comprising charging the auxiliary battery.

20. The method of claim 18, wherein the system further comprises a second battery electrically coupled to the auxiliary battery and the method further comprises charging the second battery via one of the generator or the auxiliary battery.
